(19) United States
(12) Patent Application Publication
(10) Pub. No.: US 2026/0175664 A1
(43) Pub. Date: Jun. 25, 2026

(54) GLASS RUN

(71) Applicant: TOYODA GOSEI CO., LTD., Kiyosu-shi (JP)

(72) Inventor: Tsubasa SHINODA, Kiyosu-shi (JP)

(21) Appl. No.: 19/401,676

(22) Filed: Nov. 26, 2025

(30) Foreign Application Priority Data
Dec. 24, 2024 (JP) 2024-227080

(51) Int. Cl. B60J 10/763; B60J 10/16; B60J 10/27; B60R 13/04

(52) U.S. Cl. CPC B60J 10/763; B60J 10/16; B60J 10/27; B60R 13/04

(57) ABSTRACT

A glass run includes a trim portion that is attached to a door frame, and a glass run portion that is formed integrally with the trim portion, in which the glass run portion includes a vehicle outer side wall connected to the trim portion, a vehicle inner side wall, and a vehicle outer seal lip and a vehicle inner seal lip that come into contact with a vehicle outer side and a vehicle inner side of a door glass, respectively, the trim portion includes a trim portion hard portion having a high hardness, the glass run portion includes a glass run portion hard portion having a high hardness in part, and at least when the door glass is closed, the door glass and the glass run portion hard portion, and the glass run portion hard portion and the trim portion hard portion, are in contact with each other.

### CROSS REFERENCE TO RELATED APPLICATION

This application claims the priority benefit of Japanese Patent Application No. 2024-227080 filed on Dec. 24, 2024. The entirely of the above-mentioned patent application is hereby incorporated by reference herein and made a part of this application.

### BACKGROUND OF THE INVENTION

### (1) Field of the Invention

The present invention relates to a glass run disposed on a door frame of an automobile door, and more particularly to a glass run that is assembled from the vehicle outer side of the door frame.

### (2) Description of Related Art

Improving quietness of vehicles such as automobiles enhances the comfort of occupants and therefore serves as a strong appeal point for improving product value. Further, in electric vehicles, which are becoming increasingly widespread, the conventional engine is no longer installed, and with the elimination of engine noise, the primary remaining noises that become noticeable are road noise and wind noise. Therefore, there is an increasing need for these reduction techniques.

For example, there is known a technique of reducing vibration by using impedance matching that brings the impedance of a glass run close to the impedance of glass by increasing the rigidity of the glass run (for example, Japanese Patent Application Laid-Open No. 2023-53894).

FIG. 9 illustrates a technique disclosed in Japanese Patent Application Laid-Open No. 2023-53894. A glass run 100 includes a bottom wall 200, a vehicle outer side wall 300, and a vehicle inner side wall 400 as its basic structure. The basic structure is attached to a door frame groove portion 500 formed in a door frame 310 and guides the raising and lowering of a door glass 600. On the vehicle inner side of the vehicle outer side wall 300, a thick portion 330 having a hardness higher than that of the vehicle outer side wall main body portion 320 of the vehicle outer side wall 300 is formed to protrude toward the vehicle inner side and come into sliding contact with the door glass 600.

When the thick portion 330 having high hardness comes into contact with the door glass 600, vibration can be reduced by efficiently transmitting the vibration energy of the door glass 600 to the glass run 100 through impedance matching.

Further, by bringing the vehicle outer side wall 300, on which the thick portion 330 having high hardness is formed, into contact with the door frame groove portion 500 to form a structure in which the door glass 600 and the door frame groove portion 500 sandwich the vehicle outer side wall 300 including the thick portion 330, it is also possible to increase the rigidity of the vehicle outer side wall with respect to the door glass 600 and the door frame groove portion 500 and reduce vibration.

### SUMMARY OF THE INVENTION

Incidentally, in addition to the type that is assembled to a door frame groove portion 500 as illustrated in FIG. 9, there also exists a so-called hidden type glass run, which, in response to vehicle design requirements, covers and conceals from the vehicle outer side a portion of the door frame in which an outer panel and an inner panel are integrated at their tip end portions.

The reduction of vibration of the door glass in a glass run that is assembled from the vehicle outer side to this type of door frame has not yet been sufficiently studied at the present time.

The present invention relates to a glass run that is assembled from the vehicle outer side of a door frame, and is intended to provide a glass run capable of sufficiently exhibiting the effect of reducing vibration by utilizing impedance matching with a door glass.

In order to solve the above problems, a first aspect of the present invention is a glass run that is assembled from a vehicle outer side to a door frame extending to form a door glass opening of an automobile door, and that seals between the door frame and a door glass, the glass run including a trim portion that is attached to a vehicle outer flange portion of the door frame, and a glass run portion that is formed integrally with the trim portion, attached to a vehicle inner flange portion of the door frame, and seals between the door frame and the door glass, in which the glass run portion includes a vehicle outer side wall connected to the trim portion, a vehicle inner side wall, a vehicle outer seal lip that comes into contact with a vehicle outer side of the door glass, and a vehicle inner seal lip that comes into contact with a vehicle inner side of the door glass, the trim portion includes a trim portion hard portion made of a material having a high hardness in whole or in part, the glass run portion includes a glass run portion hard portion made of a material having a high hardness in part, and at least when the door glass is closed, the door glass and the glass run portion hard portion, and the glass run portion hard portion and the trim portion hard portion, are in contact with each other.

In the first aspect of the present invention, the glass run includes a trim portion that is attached to a vehicle outer flange portion of a door frame, and a glass run portion that is formed integrally with the trim portion, attached to a vehicle inner flange portion of the door frame, and seals between the door frame and a door glass, the glass run portion includes a vehicle outer side wall connected to the trim portion, a vehicle inner side wall, a vehicle outer seal lip that comes into contact with a vehicle outer side of the door glass, and a vehicle inner seal lip that comes into contact with a vehicle inner side of the door glass, the trim portion includes a trim portion hard portion made of a material having a high hardness in whole or in part, and the glass run portion includes a glass run portion hard portion made of a material having a high hardness in part. Then, since the door glass and the glass run portion hard portion come into contact with each other at least when the door glass is closed, the vibration energy of the door glass can be efficiently transmitted to the glass run portion hard portion by utilizing impedance matching.

Further, since the glass run portion hard portion and the trim portion hard portion are in contact with each other, the vibration energy of the door glass transmitted to the glass run portion hard portion can be dissipated into the trim portion hard portion. As a result, even in a glass run of the type assembled from the vehicle outer side of the door frame, it is possible to reduce the vibration of the door glass by utilizing impedance matching that makes the impedance of the glass run closer to the impedance of the door glass.

If the trim portion hard portion is formed to come into contact with the vehicle outer flange portion of the door frame in the trim portion, the vibration energy of the door glass can be further dissipated from the trim portion hard portion into the door frame.

A second aspect of the present invention is the glass run according to the first aspect, in which the trim portion hard portion extends to the vehicle outer side wall or the vehicle inner side wall of the glass run portion.

In a glass run that is assembled from the vehicle outer side to a door frame extending to form a door glass opening of an automobile door, the trim portion is assembled to a vehicle outer flange portion, and the vehicle inner wall side is assembled to a vehicle inner flange portion. Therefore, the vehicle inner side wall is formed larger than the vehicle outer side wall, and a plurality of vehicle inner seal lips are often formed. Further, since the vehicle outer side wall is very short, a vehicle outer seal lip that is formed on the vehicle inner side and on the trim portion side at a tip end portion of the vehicle outer side wall does not come into contact with the trim portion.

In the second aspect of the present invention, the trim portion hard portion is formed to extend to the vehicle outer side wall or the vehicle inner side wall of the glass run portion. In a case where the trim portion hard portion is formed to extend to the vehicle outer side wall of the glass run portion, a glass run portion hard portion may be formed in the vehicle outer seal lip, and the glass run portion hard portion of the vehicle outer seal lip and the trim portion hard portion formed to extend to the vehicle outer side wall may be brought into contact with each other. Accordingly, the vibration energy of the door glass can be transmitted from the door glass to the glass run portion hard portion and dissipated from the glass run portion hard portion to the trim portion hard portion.

On the other hand, in a case where the trim portion hard portion is formed to extend to the vehicle inner side wall of the glass run portion, the glass run portion hard portion may be formed in a vehicle inner seal lip located particularly at a position away from the trim portion among a plurality of vehicle inner seal lips, and the glass run portion hard portion of the vehicle inner seal lip and the trim portion hard portion formed to extend to the vehicle inner side wall may be brought into contact with each other. Accordingly, the vibration energy of the door glass can be transmitted from the door glass to the glass run portion hard portion and dissipated from the glass run portion hard portion to the trim portion hard portion.

As a result, vibration of the door glass can be reduced by utilizing impedance matching that brings the impedance of the glass run closer to the impedance of the door glass.

A third aspect of the present invention is a glass run that is assembled from a vehicle outer side to a door frame extending to form a door glass opening of an automobile door, and that seals between the door frame and a door glass, the glass run including a trim portion that is attached to a vehicle outer flange portion of the door frame, and a glass run portion that is formed integrally with the trim portion, attached to a vehicle inner flange portion of the door frame, and seals between the door frame and the door glass, in which an insert member having a higher hardness than the trim portion is embedded at least on the door glass side of the vehicle outer flange portion of the trim portion, the glass run portion includes a vehicle inner side wall connected to the trim portion, and a vehicle inner seal lip that comes into contact with a vehicle inner side of the door glass, a vehicle inner seal lip hard portion having a higher hardness than the remainder of the vehicle inner seal lip except for a tip end portion is provided at the tip end portion of the vehicle inner seal lip, and at least when the door glass is closed, the door glass and the vehicle inner seal lip hard portion, and the vehicle inner seal lip hard portion and the trim portion, are in contact with each other.

In the third aspect of the present invention, since an insert member having a higher hardness than the trim portion is embedded at least on the door glass side of the vehicle outer flange portion of the trim portion, the rigidity on the door glass side of the trim portion is increased.

The glass run portion includes a vehicle inner side wall connected to the trim portion, and a vehicle inner seal lip that comes into contact with a vehicle inner side of the door glass, a vehicle inner seal lip hard portion having a higher hardness than the remainder of the vehicle inner seal lip except for its tip end portion is provided at a tip end portion of the vehicle inner seal lip, and since the door glass and the vehicle inner seal lip hard portion come into contact with each other at least when the door glass is closed, the vibration energy of the door glass can be efficiently transmitted to the vehicle inner seal lip hard portion by utilizing impedance matching.

Then, since the vehicle inner seal lip hard portion and the trim portion are in contact with each other, the vibration energy of the door glass transmitted to the vehicle inner seal lip hard portion can be dissipated into the trim portion whose rigidity has been increased.

As a result, vibration of the door glass can be reduced by utilizing impedance matching that brings the impedance of the glass run closer to the impedance of the door glass.

Here, the “rigidity of the trim portion” is expressed by the amount of increase in reaction force from the trim portion with respect to the displacement amount at a pressed portion when the trim portion is pressed. Accordingly, by embedding the insert member on the door glass side of the vehicle outer flange portion in the trim portion, the slope (gradient) in the relationship between displacement and reaction force becomes greater.

A fourth aspect of the present invention is a glass run that is assembled from a vehicle outer side to a door frame extending to form a door glass opening of an automobile door, and that seals between the door frame and a door glass, the glass run including a trim portion that is attached to a vehicle outer flange portion of the door frame, and a glass run portion that is formed integrally with the trim portion, attached to a vehicle inner flange portion of the door frame, and seals between the door frame and the door glass, in which the glass run portion includes a vehicle outer side wall connected to the trim portion, and a vehicle outer seal lip extending from the vehicle outer side wall toward the door glass side, an insert member having a higher hardness than the trim portion is embedded in at least the door glass side of the vehicle outer flange portion of the trim portion and in the vehicle outer side wall, a vehicle outer seal lip hard portion having a higher hardness than the remainder of the vehicle outer seal lip except for its tip end portion is provided at a tip end portion of the vehicle outer seal lip, and at least when the door glass is closed, the door glass and the vehicle outer seal lip hard portion, and the vehicle outer side wall in a region in which the insert member is embedded and the vehicle outer seal lip hard portion, are in contact with each other.

In the fourth aspect of the present invention, the glass run includes a trim portion that is attached to a vehicle outer flange portion of a door frame, and a glass run portion that is formed integrally with the trim portion, attached to a vehicle inner flange portion of the door frame, and seals between the door frame and a door glass, in which the glass run portion includes a vehicle outer side wall connected to the trim portion and a vehicle outer seal lip extending from the vehicle outer side wall toward the door glass side, an insert member having a higher hardness than the trim portion is embedded in at least the door glass side of the vehicle outer flange portion of the trim portion and in the vehicle outer side wall, a vehicle outer seal lip hard portion having a higher hardness than the remainder of the vehicle outer seal lip except for its tip end portion is provided at a tip end portion of the vehicle outer seal lip, and since the door glass and the vehicle outer seal lip hard portion come into contact with each other at least when the door glass is closed, the vibration energy of the door glass can be efficiently transmitted to the lip hard portion by utilizing impedance matching.

Then, since the vehicle outer seal lip hard portion and the vehicle outer side wall in a region in which the insert member is embedded are in contact with each other, the vibration energy of the door glass transmitted to the vehicle outer seal lip hard portion can be dissipated into the vehicle outer side wall whose rigidity has been increased.

As a result, vibration of the door glass can be reduced by utilizing impedance matching that brings the impedance of the glass run closer to the impedance of the door glass.

A fifth aspect of the present invention is a glass run that is assembled from the vehicle outer side to a door frame extending to form a door glass opening of an automobile door, and that seals between the door frame and a door glass, the glass run including a trim portion that is attached to a vehicle outer flange portion of the door frame, and a glass run portion that is formed integrally with the trim portion, attached to a vehicle inner flange portion of the door frame, and seals between the door frame and the door glass, in which the glass run portion includes a vehicle inner side wall connected to the trim portion, and a vehicle inner seal lip extending from the vehicle inner side wall toward the door glass side, an insert member having a higher hardness than the trim portion is embedded in at least the door glass side of the vehicle outer flange portion of the trim portion and in the vehicle inner side wall, a vehicle inner seal lip hard portion having a higher hardness than the remainder of the vehicle inner seal lip except for its tip end portion is formed at a tip end portion of the vehicle inner seal lip, and at least when the door glass is closed, the door glass and the vehicle inner seal lip hard portion, and the vehicle inner side wall in a region in which the insert member is embedded and the vehicle inner seal lip hard portion, are in contact with each other.

In the fifth aspect of the present invention, the glass run includes a trim portion that is attached to a vehicle outer flange portion of a door frame, and a glass run portion that is formed integrally with the trim portion, attached to a vehicle inner flange portion of the door frame, and seals between the door frame and a door glass, in which the glass run portion includes a vehicle inner side wall connected to the trim portion and a vehicle inner seal lip extending from the vehicle inner side wall toward the door glass side, an insert member having a higher hardness than the trim portion is embedded in at least the door glass side of the vehicle outer flange portion of the trim portion and in the vehicle inner side wall, a vehicle inner seal lip hard portion having a higher hardness than the remainder of the vehicle inner seal lip except for its tip end portion is formed at a tip end portion of the vehicle inner seal lip, and since the door glass and the vehicle inner seal lip hard portion come into contact with each other at least when the door glass is closed, the vibration energy of the door glass can be efficiently transmitted to the vehicle inner seal lip hard portion by utilizing impedance matching.

Then, since the vehicle inner seal lip hard portion and the vehicle inner side wall in a region in which the insert member is embedded are in contact with each other, the vibration energy of the door glass transmitted to the vehicle inner seal lip hard portion can be dissipated into the vehicle inner side wall whose rigidity has been increased.

As a result, vibration of the door glass can be reduced by utilizing impedance matching that brings the impedance of the glass run closer to the impedance of the door glass.

A sixth aspect of the present invention is the glass run according to the fifth aspect, in which the insert member has a substantially U-shaped cross section in the trim portion, and is continuously formed and embedded from the door glass side of the vehicle outer flange portion into the vehicle inner side wall.

In the sixth aspect of the present invention, since the insert member has a substantially U-shaped cross section in the trim portion and is continuously formed and embedded from the door glass side of the vehicle outer flange portion into the vehicle inner side wall, by extending the insert member from the tip end portion of the substantially U-shaped shape into the vehicle inner side wall, it can be manufactured as a single member. As a result, the extrusion molding of the glass run can be efficiently performed.

### BRIEF DESCRIPTION OF THE DRAWINGS

FIG. 1 is a left side view of an automobile;

FIG. 2 is a front view of a glass run used for a left front door according to the embodiment of the present invention;

FIG. 3 is a cross-sectional view taken along line A-A of FIG. 1 according to a first embodiment of the present invention;

FIG. 4 is a cross-sectional view taken along line A-A of FIG. 1 according to a second embodiment of the present invention;

FIG. 5 is a cross-sectional view taken along line A-A of FIG. 1 according to a third embodiment of the present invention;

FIG. 6 is a cross-sectional view taken along line A-A of FIG. 1 according to a fourth embodiment of the present invention;

FIG. 7 is a cross-sectional view taken along line A-A of FIG. 1 according to a fifth embodiment of the present invention;

FIG. 8 is a cross-sectional view taken along line A-A of FIG. 1 according to a sixth embodiment of the present invention; and

FIG. 9 is a cross-sectional view illustrating an attachment structure of a conventional glass run (Japanese Patent Application Laid-Open No. 2023-53894).

### DETAILED DESCRIPTION OF PREFERRED EMBODIMENTS

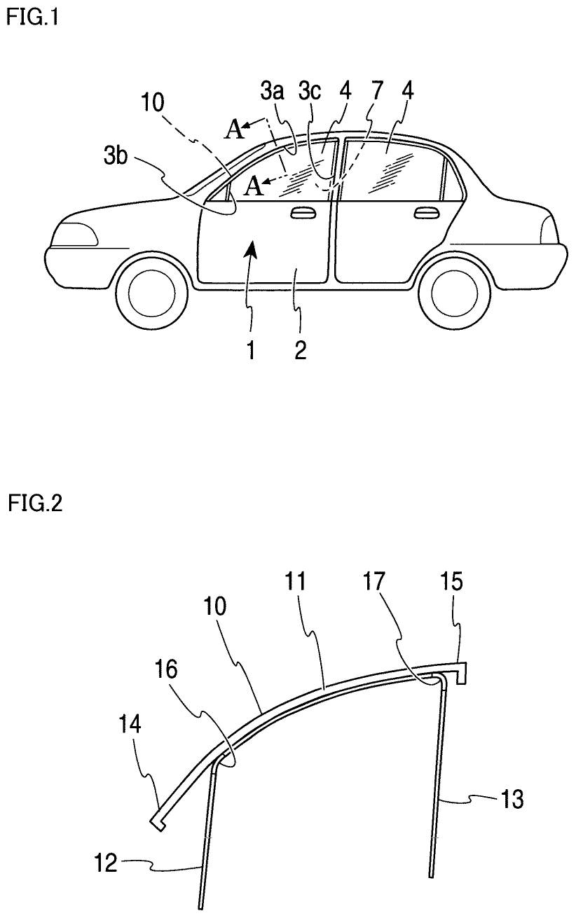

A first embodiment of the present invention will be described with reference to FIGS. 1 to 3. FIG. 1 is a left side view of an automobile. A left front door 1 includes a door main body 2 constituting a substantially lower half portion of the left front door 1, and a door frame 3 (3a, 3b, 3c) constituting a substantially upper half portion thereof. A door glass 4, which moves up and down, and a lift device (not illustrated) for raising and lowering the door glass 4, are housed inside the door main body 2. It should be noted that the present invention is applicable not only to the left front door 1, but also to a right front door and both right and left rear doors.

Further, FIGS. 1 and 2 are also used in the description of second to sixth embodiments described later.

### (Door Frame 3)

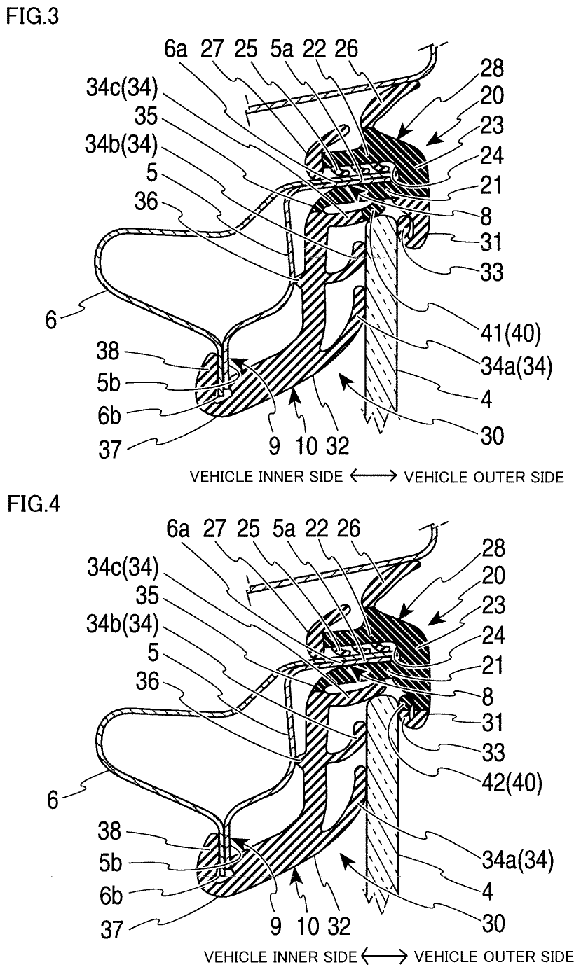

The door frame 3 functions as a sash that holds a peripheral edge portion of the door glass 4, and extends to form a door glass opening 7 generated when the door glass 4 is opened in FIG. 1. The door glass opening 7 formed by the door frame 3 is opened and closed by the door glass 4. As illustrated in FIG. 3, the door frame 3 of the present embodiment is formed by combining an outer panel 5 formed by press-molding a steel plate or the like and an inner panel 6.

FIG. 2 is a front view of the glass run 10 according to the embodiment of the present invention. As illustrated in FIG. 2, the glass run 10 includes an upper side portion 11, a front vertical portion 12, a rear vertical portion 13, a front projecting portion 14, and a rear projecting portion 15. The upper side portion 11 extends in the front-rear direction along a frame upper side portion 3a (FIG. 1) which is an upper portion of the door frame 3. The front vertical portion 12 extends downward from a front end of the upper side portion 11 along the front frame portion 3b (FIG. 1) of the door frame 3. The rear vertical portion 13 extends downward from a rear end portion of the upper side portion 11 along a rear frame portion 3c (FIG. 1) of the door frame 3. The lower ends of the front vertical portion 12 and the rear vertical portion 13 extend down to a position reaching the inside of the door main body 2.

A front corner portion 16 is formed at a boundary portion between the front portion of the upper side portion 11 and the front vertical portion 12. The front projecting portion 14 projects forward from the front corner portion 16 and is inclined as a whole such that the closer to the front end, the lower the position. Further, a rear corner portion 17 is formed at a boundary portion between a rear part of the upper side portion 11 and the rear vertical portion 13. The rear projecting portion 15 projects rearward from the rear corner portion 17 along the frame upper side portion 3a of the door frame 3. The rear end portion of the rear projecting portion 15 extends to reach the rear end of the frame upper side portion 3a.

FIG. 3 is a cross-sectional view taken along line A-A of FIG. 1. As illustrated in FIG. 3, the door frame 3 includes a vehicle outer flange portion 8 extending to the vehicle outer side, and a vehicle inner flange portion 9 projecting into the door glass opening 7 (FIG. 1). Since the vehicle inner flange portion 9 projects toward the inside of the door glass opening 7, the vehicle inner flange portion projects downward in the frame upper side portion 3a in FIG. 1.

On the inner side of the door glass opening 7 in the outer panel 5 constituting the door frame 3, an outer panel inner plate portion 5b extending toward the inside of the door glass opening 7 is formed. On the inner side of the door glass opening 7 in the inner panel 6, an inner panel inner plate portion 6b extending toward the inside of the door glass opening 7 is formed. Further, on the outer side of the door glass opening 7 in the outer panel 5, an outer panel outer plate portion 5a extending toward the vehicle outer side is formed. On the outer side of the door glass opening 7 in the inner panel 6, an inner panel outer plate portion 6a extending toward the vehicle outer side is formed.

Then, by overlapping and joining the outer panel inner plate portion 5b of the outer panel 5 and the inner panel inner plate portion 6b of the inner panel 6 in the vehicle width direction, a vehicle inner flange portion 9 is formed. Further, by overlapping and joining the outer panel outer plate portion 5a of the outer panel 5 and the inner panel outer plate portion 6a of the inner panel 6 in the vertical direction, the vehicle outer flange portion 8 is formed.

### (Glass Run 10)

As illustrated in FIG. 3, the glass run 10 attached to the frame upper side portion 3a of the door frame 3 includes a trim portion 20 that is attached to the vehicle outer flange portion 8 of the door frame 3, and a glass run portion 30 that is attached to the vehicle inner flange portion 9 of the door frame 3.

The trim portion 20 includes a door glass side wall 21 located on the door glass 4 side, a body side wall 22 facing a peripheral edge of a vehicle body opening, and a trim portion bottom wall 23 connecting the door glass side wall 21 and the body side wall 22, and has a substantially U-shaped cross section.

On the body side wall 22, which defines a trim portion recess 24 serving as the interior of the substantially U-shaped cross section, three recessed lips 25 are provided.

The body side wall 22 is provided with an upper seal lip 26 that extends toward the vehicle outer side and toward the peripheral edge of the vehicle body opening, and that comes into contact with the peripheral edge of the vehicle body opening when the left front door 1 is closed.

Further, a trim portion holding portion 27 is provided at a tip end of the body side wall 22.

The door glass side wall 21, the body side wall 22, and the trim portion bottom wall 23 of the trim portion 20 are formed of a material having hardness higher than that of the materials constituting the recessed lip 25, the upper seal lip 26, and the trim portion holding portion 27, and constitute a trim portion hard portion 28.

As illustrated in FIG. 3, when the vehicle outer flange portion 8 is inserted into the trim portion recess 24, the door glass side wall 21 comes into contact with the outer panel outer plate portion 5a of the vehicle outer flange portion 8, and the recessed lips 25 come into contact with the inner panel outer plate portion 6a of the inner panel 6 to sandwich the vehicle outer flange portion 8. Further, the trim portion holding portion 27 comes into contact with the vehicle outer flange portion 8, thereby clamping the vehicle outer flange portion 8 with the trim portion 20 and holding the glass run 10 on the door frame 3.

The glass run portion 30 is located below the trim portion 20 and includes a vehicle outer side wall 31 connected to the door glass side wall 21 of the trim portion 20, and a vehicle inner side wall 32. The vehicle outer side wall 31 extends downward. On the other hand, the vehicle inner side wall 32 is formed larger than the vehicle outer side wall 31 and includes a portion that is extended downward and a portion that is extended from the downwardly extended portion and largely curved toward the vehicle inner side.

Further, the portion that is extended to be largely curved toward the vehicle inner side is formed to be thicker than the portion that is extended downward.

A vehicle outer seal lip 33 is provided to extend from a tip end of the vehicle outer side wall 31 toward the vehicle inner side and toward the door glass side wall 21 of the trim portion 20.

Further, the vehicle inner side wall 32 is provided with a vehicle inner seal lip 34 extending toward the vehicle outer side and toward the door glass side wall 21 of the trim portion 20. In the present embodiment, the vehicle inner seal lip 34 is composed of three lips, namely, a first vehicle inner seal lip 34a, a second vehicle inner seal lip 34b, and a third vehicle inner seal lip 34c, arranged from the lower side upward. The first vehicle inner seal lip 34a is formed in a transition portion between the portion that is extended downward and the portion that is extended to be largely curved toward the vehicle inner side.

A vehicle inner seal lip hard portion 41 (glass run portion hard portion 40) having a high hardness is provided at a tip end portion of the third vehicle inner seal lip 34c.

A thin hinge portion 35 is provided at a connecting portion between the vehicle inner side wall 32 and the door glass side wall 21 of the trim portion 20, so that the vehicle inner side wall 32 can pivot about a hinge portion 35 when the glass run portion 30 is attached.

A contact rib 36 is formed on the vehicle inner side of the vehicle inner side wall 32.

Further, the vehicle inner side wall 32 is thinned at its tip end portion by a stepped portion 37 and is provided with a vehicle inner decorative lip 38 that is curved in a hook shape.

As illustrated in FIG. 3, when the vehicle inner flange portion 9 is inserted between the stepped portion 37 and the vehicle inner decorative lip 38, a tip end portion of the stepped portion 37 comes into contact with the outer panel inner plate portion 5b of the vehicle inner flange portion 9, and the vehicle inner decorative lip 38 comes into contact with the inner panel inner plate portion 6b, thereby sandwiching the vehicle inner flange portion 9, clamping the vehicle inner flange portion 9 with the glass run portion 30, and holding the glass run 10 on the door frame 3. Further, the contact rib 36 comes into contact with the outer panel 5.

In the present embodiment, the trim portion hard portion 28 and the vehicle inner seal lip hard portion 41 (glass run portion hard portion 40) are made of polypropylene (PP). The trim portion 20 excluding the trim portion hard portion 28, and the glass run portion 30 excluding the vehicle inner seal lip hard portion 41 (glass run portion hard portion 40), are made of an olefin-based thermoplastic elastomer (TPO) having an International Rubber Hardness Degree (IRHD) of 80±5, and are manufactured by extrusion molding. It is also possible to use the same TPO as that used for other portions for the trim portion hard portion 28 and the vehicle inner seal lip hard portion 41 (glass run portion hard portion 40), and in such a case, it is preferable that the IRHD be 100±5. Further, a hard resin material other than PP, for example, an olefin-based resin such as polystyrene, may be used.

When the glass run 10 is assembled to the door frame 3 from the vehicle outer side and the door glass 4 is closed, the first vehicle inner seal lip 34a and the second vehicle inner seal lip 34b come into contact with the vehicle inner side of the door glass 4, and the vehicle inner seal lip hard portion 41 of the third vehicle inner seal lip 34c comes into contact with the tip end portion of the door glass 4 and with the trim portion hard portion 28 (door glass side wall 21) of the trim portion 20.

Next, a second embodiment of the present invention will be described with reference to FIG. 4. FIG. 4 is a cross-sectional view taken along line A-A of FIG. 1. The differences between the present second embodiment and the above first embodiment are as follows. In the present second embodiment, first, the glass run portion hard portion 40 is formed at a tip end portion of the vehicle outer seal lip 33 and serves as a vehicle outer seal lip hard portion 42, second, the trim portion hard portion 28 is formed to extend to an intermediate portion of the vehicle outer side wall 31, and third, the vehicle inner seal lip hard portion 41 is not formed.

Then, when the glass run 10 is assembled to the door frame 3 and the door glass 4 is closed, the vehicle outer seal lip hard portion 42 (glass run portion hard portion 40) comes into contact with the door glass 4 and with the trim portion hard portion 28 which is formed to extend to an intermediate portion of the vehicle outer side wall 31.

Next, a third embodiment of the present invention will be described with reference to FIG. 5. FIG. 5 is a cross-sectional view taken along line A-A of FIG. 1. The differences between the present third embodiment and the above first embodiment are that, in the present third embodiment, first, the trim portion hard portion 28 is formed to extend into the vehicle inner side wall 32, second, a part of the vehicle inner side wall 32 portion of the trim portion hard portion 28 that extends into the vehicle inner side wall 32 is formed to project toward the vehicle interior side, third, the vehicle inner seal lip hard portion 41 (glass run portion hard portion 40) is formed on the tip end portion side of the second vehicle inner seal lip 34b instead of on the third vehicle inner seal lip 34c, fourth, the second vehicle inner seal lip 34b is formed large, and its base portion is located lower, and after being extended toward the vehicle outer side and the trim portion 20 side, it is bent toward the vehicle inner side wall 32 side in the vicinity of the vehicle inner seal lip hard portion 41, and fifth, the first vehicle inner seal lip 34a is formed small. The fifth difference results from the fourth difference, and serves to prevent the second vehicle inner seal lip 34b from coming into contact with the first vehicle inner seal lip 34a.

Then, when the glass run 10 is assembled to the door frame 3, the vehicle inner side projecting portion of the vehicle inner side wall 32 of the trim portion hard portion 28, which extends into the vehicle inner side wall 32, comes into contact with the outer panel 5. When the door glass 4 is closed, the vehicle inner seal lip hard portion 41 (glass run portion hard portion 40) comes into contact with the door glass 4 near the bent portion near the second vehicle inner seal lip 34b, and its tip end portion comes into contact with the trim portion hard portion 28 that extends into the vehicle inner side wall 32.

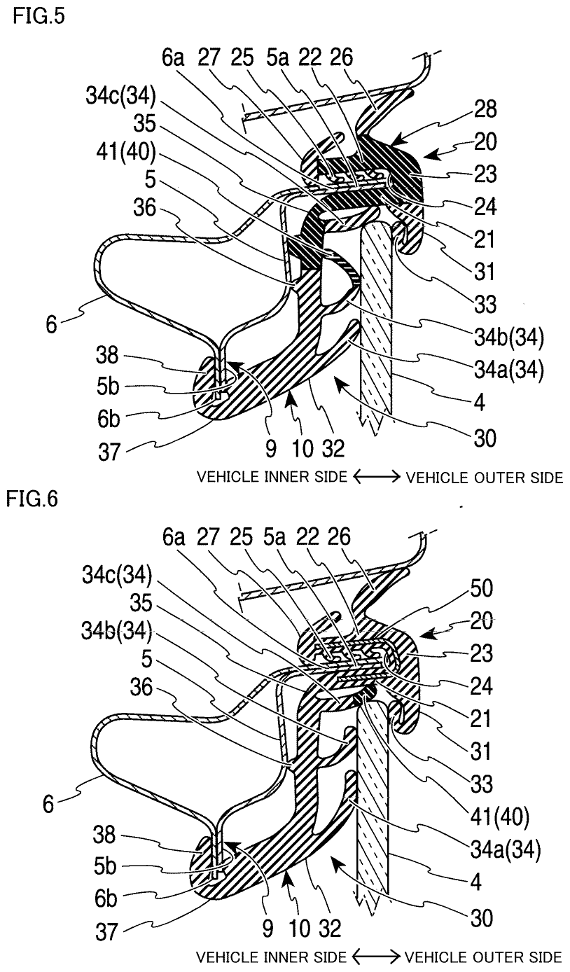

Next, a fourth embodiment of the present invention will be described with reference to FIG. 6. FIG. 6 is a cross-sectional view taken along line A-A of FIG. 1. The differences between the present fourth embodiment and the above first embodiment are as follows. In the present fourth embodiment, first, the trim portion 20 does not include the trim portion hard portion 28, and second, an insert member 50 having a substantially U-shaped cross section is embedded in the trim portion 20. The vehicle inner seal lip hard portion 41 (glass run portion hard portion 40) is formed at a tip end portion side of the third vehicle inner seal lip 34c, as in the first embodiment.

The insert member 50 is made of a metallic material. However, the insert member 50 is not limited to a metallic material, as long as it is made of a material having higher hardness than that of the trim portion 20.

Further, the insert member 50 only needs to be embedded in the door glass side wall 21 of the trim portion 20, and its cross-sectional shape is not limited to a substantially U-shape.

Then, when the glass run 10 is assembled to the door frame 3 and the door glass 4 is closed, the vehicle inner seal lip hard portion 41 of the third vehicle inner seal lip 34c comes into contact with the tip end portion of the door glass 4 and the door glass side wall 21 of the trim portion 20.

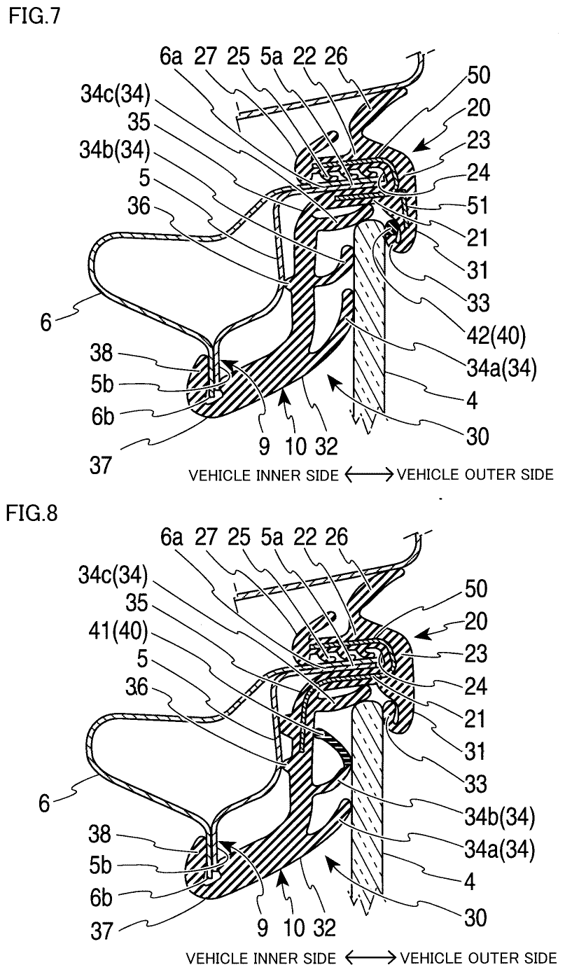

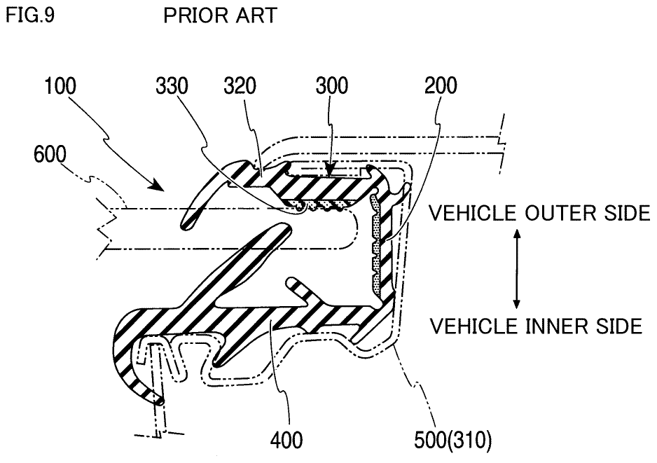

Next, a fifth embodiment of the present invention will be described with reference to FIG. 7. FIG. 7 is a cross-sectional view taken along line A-A of FIG. 1. The differences between the present fifth embodiment and the above second embodiment are as follows. In the present fifth embodiment, first, neither the trim portion 20 nor the vehicle outer side wall 31 includes the trim portion hard portion 28, second, the insert member 50 having a substantially U-shaped cross section is embedded in the trim portion 20, and third, a second insert member 51 is embedded in the vehicle outer side wall 31.

Then, when the glass run 10 is assembled to the door frame 3 and the door glass 4 is closed, the vehicle outer seal lip hard portion 42 (glass run portion hard portion 40) comes into contact with the door glass 4 and the vehicle outer side wall 31 in a region where the second insert member 51 is embedded.

Next, a sixth embodiment of the present invention will be described with reference to FIG. 8. FIG. 8 is a cross-sectional view taken along line A-A of FIG. 1. The differences between the present sixth embodiment and the above third embodiment are as follows. In the present sixth embodiment, first, neither the trim portion 20 nor the vehicle inner side wall 32 includes the trim portion hard portion 28, second, the insert member 50 having a substantially U-shaped cross section is embedded in the trim portion 20, and third, the insert member 50 is embedded to extend from the tip end portion on the door glass side wall 21 side to the vehicle inner side wall 32.

Then, when the glass run 10 is assembled to the door frame 3 and the door glass 4 is closed, the vehicle inner seal lip hard portion 41 (glass run portion hard portion 40) comes into contact with the door glass 4 near the bent portion of the second vehicle inner seal lip 34b, and its tip end portion comes into contact with the vehicle inner side wall 32 in a region where the insert member 50 is embedded.

As described in detail above, according to the embodiments of the present invention, the following effects can be obtained.
(1) In the above first embodiment, the glass run 10 includes the trim portion 20 that is attached to the vehicle outer flange portion 8 of the door frame 3, and the glass run portion 30 that is formed integrally with the trim portion 20, attached to the vehicle inner flange portion 9 of the door frame 3, and seals between the door frame 3 and the door glass 4, in which the glass run portion 30 includes the vehicle outer side wall 31 connected to the trim portion 20, the vehicle inner side wall 32, the vehicle outer seal lip 33 that comes into contact with the vehicle outer side of the door glass 4, and the vehicle inner seal lip 34 that comes into contact with the vehicle inner side of the door glass 4, the trim portion 20 includes the trim portion hard portion 28 made of a material having a high hardness in the door glass side wall 21, the body side wall 22, and the trim portion bottom wall 23 that connects the door glass side wall 21 and the body side wall 22, the glass run portion 30 includes, at a tip end portion of the third vehicle inner seal lip 34c of the vehicle inner seal lip 34, the vehicle inner seal lip hard portion 41 (glass run portion hard portion 40) made of a material having a high hardness, and since at least when the door glass 4 is closed, the door glass 4 and the glass run portion hard portion 40 come into contact with each other, even in the glass run 10 of a type assembled from the vehicle outer side to the door frame 3 extending to form the door glass opening 7 of the left front door 1 and sealing between the door frame 3 and the door glass 4, it is possible to efficiently transmit the vibration energy of the door glass 4 to the glass run portion hard portion 40 by utilizing impedance matching through the contact between the door glass 4 and the glass run portion hard portion 40.
(2) Further, since the glass run portion hard portion 40 and the trim portion hard portion 28 are in contact with each other, the vibration energy of the door glass 4 transmitted to the glass run portion hard portion 40 can be dissipated into the trim portion hard portion 28. As a result, vibration of the door glass 4 can be reduced by utilizing impedance matching that brings the impedance of the glass run 10 closer to the impedance of the door glass 4.
(3) Further, since the trim portion hard portion 28 of the trim portion 20 comes into contact with the vehicle outer flange portion 8 of the door frame 3, the vibration energy of the door glass 4 can be further dissipated from the trim portion hard portion 28 into the vehicle outer flange portion 8 of the door frame 3. As a result, vibration of the door glass 4 can be further reduced by utilizing impedance matching that brings the impedance of the glass run 4 closer to the impedance of the glass run 10.
(4) In the above second embodiment, the glass run portion hard portion 40 is the vehicle outer seal lip hard portion 42 formed at the tip end portion of the vehicle outer seal lip 33, and since the trim portion hard portion 28 is formed to extend to an intermediate portion of the vehicle outer side wall 31, when the glass run 10 is assembled to the door frame 3 and the door glass 4 is closed, the vibration energy of the door glass 4 can be efficiently transmitted to the glass run portion hard portion 40 by utilizing impedance matching through the contact between the door glass 4 and the glass run portion hard portion 40. Further, since the glass run portion hard portion 40 comes into contact with the trim portion hard portion 28 that is formed to extend into the vehicle outer side wall 31, the vibration energy of the door glass 4 transmitted to the glass run portion hard portion 40 can be dissipated into the trim portion hard portion 28. As a result, vibration of the door glass 4 can be reduced by utilizing impedance matching that brings the impedance of the glass run 10 closer to the impedance of the door glass 4.
(5) Further, since the vehicle outer seal lip hard portion 42 is not formed in a portion of the vehicle outer seal lip 33 that greatly bends and deforms when the vehicle outer seal lip comes into contact with the door glass 4, it does not adversely affect the sliding contact with the door glass 4.
(6) In the above third embodiment, since the vehicle inner seal lip hard portion 41 (glass run portion hard portion 40) is formed on the tip end portion side of the second vehicle inner seal lip 34b, the second vehicle inner seal lip 34b extends toward the vehicle outer side and the trim portion 20 side and then bends toward the vehicle inner side wall 32 side near the vehicle inner seal lip hard portion 41, the trim portion hard portion 28 is formed to extend to an intermediate portion of the vehicle inner side wall 32, and a part of the vehicle inner side wall 32 portion of the trim portion hard portion 28 that extends into the vehicle inner side wall 32 projects toward the vehicle interior side, when the glass run 10 is assembled to the door frame 3, the trim portion hard portion 28 comes into contact with the vehicle outer flange portion 8 of the door frame 3, and the vehicle inner side projecting portion of the vehicle inner side wall 32 of the trim portion hard portion 28 that extends into the vehicle inner side wall 32 comes into contact with the outer panel 5.

Then, when the door glass 4 is closed, since the vehicle inner seal lip hard portion 41 (glass run portion hard portion 40) comes into contact with the door glass 4 near the bent portion of the second vehicle inner seal lip 34b, the vibration energy of the door glass 4 can be efficiently transmitted to the glass run portion hard portion 40 by utilizing impedance matching. Further, since the tip end portion of the glass run portion hard portion 40 comes into contact with the trim portion hard portion 28 that extends into the vehicle inner side wall 32, the vibration energy of the door glass 4 transmitted to the glass run portion hard portion 40 can be dissipated into the trim portion hard portion 28. As a result, vibration of the door glass 4 can be reduced by utilizing impedance matching that brings the impedance of the glass run 10 closer to the impedance of the door glass 4.
(7) Further, in the trim portion 20, since the trim portion hard portion 28 comes into contact with the vehicle outer flange portion 8 of the door frame 3 and the trim portion hard portion 28 also comes into contact with the outer panel 5, the vibration energy of the door glass 4 can be further dissipated from the trim portion hard portion 28 into the door frame 3.
(8) In the above fourth embodiment, the insert member 50 having a substantially U-shaped cross section is embedded in the trim portion 20, and the vehicle inner seal lip hard portion 41 (glass run portion hard portion 40) is formed on the tip end portion side of the third vehicle inner seal lip 34c. When the glass run 10 is assembled to the door frame 3 and the door glass 4 is closed, the vehicle inner seal lip hard portion 41 of the third vehicle inner seal lip 34c comes into contact with the door glass 4 and also comes into contact with the door glass side wall 21 of the trim portion 20. Therefore, by utilizing the impedance matching, the vibration energy of the door glass 4 can be efficiently transmitted to the glass run portion hard portion 40, and further, the vibration energy can be dissipated from the glass run portion hard portion 40 into the door glass side wall 21 of the trim portion 20 in which the insert member 50 is embedded and whose rigidity has been increased. As a result, vibration of the door glass 4 can be reduced by utilizing impedance matching that brings the impedance of the glass run 10 closer to the impedance of the door glass 4.
(9) In the above fifth embodiment, the insert member 50 having a substantially U-shaped cross section is embedded in the trim portion 20, and the second insert member 51 is embedded in the vehicle outer side wall 31, the glass run portion hard portion 40 is the vehicle outer seal lip hard portion 42 formed at the tip end portion of the vehicle outer seal lip 33, and when the glass run 10 is assembled to the door frame 3 and the door glass 4 is closed, since the vehicle outer seal lip hard portion 42 (glass run portion hard portion 40) comes into contact with the door glass 4 and the vehicle outer side wall 31 in a region where the second insert member 51 is embedded, by utilizing impedance matching, the vibration energy of the door glass 4 can be efficiently transmitted to the glass run portion hard portion 40, and the vibration energy transmitted to the glass run portion hard portion 40 can be dissipated into the vehicle outer side wall 31, whose rigidity has been increased by embedding the insert member 50. As a result, vibration of the door glass 4 can be reduced by utilizing impedance matching that brings the impedance of the glass run 10 closer to the impedance of the door glass 4.
(10) In the above sixth embodiment, since an insert member 50 having a substantially U-shaped cross section is embedded in the trim portion 20, and the insert member 50 is embedded to extend from the tip end portion on the door glass side wall 21 side into the vehicle inner side wall 32, and the glass run portion hard portion 40 is a vehicle inner seal lip hard portion 41 formed at the tip end portion of the second vehicle inner seal lip 34b of the vehicle inner seal lip 34, when the glass run 10 is assembled to the door frame 3 and the door glass 4 is closed, the vehicle inner seal lip hard portion 41 (glass run portion hard portion 40) comes into contact with the door glass 4 and the vehicle inner side wall 32 in a region where the insert member 50, which is formed to extend, is embedded, so that by utilizing impedance matching, the vibration energy of the door glass 4 can be efficiently transmitted to the glass run portion hard portion 40, and the vibration energy transmitted to the glass run portion hard portion 40 can be dissipated into the vehicle inner side wall 32 whose rigidity has been increased by embedding the insert member 50.
(11) Further, since the insert member 50 is embedded by extending from the tip end portion on the door glass side wall 21 side into the vehicle inner side wall 32, the insert member 50 can be manufactured as one member extending from the substantially U-shaped tip end portion into the vehicle inner side wall 32. As a result, the extrusion molding of the glass run 10 can be efficiently performed.

The embodiment of the present invention is not limited to the above embodiment, and various modifications can be made without departing from the object of the present invention.

For example, in the above first to third embodiments, the trim portion 20 is formed of the trim portion hard portion 28 made of a material having high hardness in almost the entire region of the door glass side wall 21, the body side wall 22, and the trim portion bottom wall 23 that connects the door glass side wall 21 and the body side wall 22; however, it is only necessary to form the trim portion hard portion 28 on the door glass side wall 21 in a region at least where it comes into contact with the glass run portion hard portion 40. In this case, it is more preferable that the door glass side wall 21 includes a continuous region that comes into contact with both the glass run portion hard portion 40 and the vehicle outer flange portion 8.

For example, in the above fifth embodiment, the second insert member 51 was embedded separately from the insert member 50 within the vehicle outer side wall 31; however, if the insert member 50 embedded in the trim portion 20 can be connected to it, the insert member may be embedded as a single integrated member, as in the sixth embodiment.

What is claimed is:

1. A glass run that is assembled from a vehicle outer side to a door frame extending to form a door glass opening of an automobile door, and that seals between the door frame and a door glass, the glass run comprising:
a trim portion that is attached to a vehicle outer flange portion of the door frame; and
a glass run portion that is formed integrally with the trim portion, attached to a vehicle inner flange portion of the door frame, and seals between the door frame and the door glass, wherein
the glass run portion includes a vehicle outer side wall connected to the trim portion, a vehicle inner side wall, a vehicle outer seal lip that comes into contact with a vehicle outer side of the door glass, and a vehicle inner seal lip that comes into contact with a vehicle inner side of the door glass,
the trim portion includes a trim portion hard portion made of a material having a high hardness in whole or in part,
the glass run portion includes a glass run portion hard portion made of a material having a high hardness in part, and
at least when the door glass is closed, the door glass and the glass run portion hard portion, and the glass run portion hard portion and the trim portion hard portion, are in contact with each other.

2. The glass run according to claim 1, wherein the trim portion hard portion extends to the vehicle outer side wall or the vehicle inner side wall of the glass run portion.

3. A glass run that is assembled from a vehicle outer side to a door frame extending to form a door glass opening of an automobile door, and that seals between the door frame and a door glass, the glass run comprising:
a trim portion that is attached to a vehicle outer flange portion of the door frame; and
a glass run portion that is formed integrally with the trim portion, attached to a vehicle inner flange portion of the door frame, and seals between the door frame and the door glass, wherein
an insert member having a higher hardness than the trim portion is embedded at least on the door glass side of the vehicle outer flange portion of the trim portion,
the glass run portion includes a vehicle inner side wall connected to the trim portion, and a vehicle inner seal lip that comes into contact with a vehicle inner side of the door glass,
a vehicle inner seal lip hard portion having a higher hardness than the remainder of the vehicle inner seal lip except for a tip end portion is provided at the tip end portion of the vehicle inner seal lip, and
at least when the door glass is closed, the door glass and the vehicle inner seal lip hard portion, and the vehicle inner seal lip hard portion and the trim portion, are in contact with each other.

4. A glass run that is assembled from a vehicle outer side to a door frame extending to form a door glass opening of an automobile door, and that seals between the door frame and a door glass, the glass run comprising:
a trim portion that is attached to a vehicle outer flange portion of the door frame; and
a glass run portion that is formed integrally with the trim portion, attached to a vehicle inner flange portion of the door frame, and seals between the door frame and the door glass, wherein
the glass run portion includes a vehicle outer side wall connected to the trim portion, and a vehicle outer seal lip extending from the vehicle outer side wall toward the door glass side,
an insert member having a higher hardness than the trim portion is embedded in at least the door glass side of the vehicle outer flange portion of the trim portion and in the vehicle outer side wall,
a vehicle outer seal lip hard portion having a higher hardness than the remainder of the vehicle outer seal lip except for its tip end portion is provided at a tip end portion of the vehicle outer seal lip, and
at least when the door glass is closed, the door glass and the vehicle outer seal lip hard portion, and the vehicle outer side wall in a region in which the insert member is embedded and the vehicle outer seal lip hard portion, are in contact with each other.

5. A glass run that is assembled from the vehicle outer side to a door frame extending to form a door glass opening of an automobile door, and that seals between the door frame and a door glass,
the glass run comprising:
a trim portion that is attached to a vehicle outer flange portion of the door frame; and
a glass run portion that is formed integrally with the trim portion, attached to a vehicle inner flange portion of the door frame, and seals between the door frame and the door glass,
wherein the glass run portion includes a vehicle inner side wall connected to the trim portion, and a vehicle inner seal lip extending from the vehicle inner side wall toward the door glass side,
an insert member having a higher hardness than the trim portion is embedded in at least the door glass side of the vehicle outer flange portion of the trim portion and in the vehicle inner side wall,
a vehicle inner seal lip hard portion having a higher hardness than the remainder of the vehicle inner seal lip except for its tip end portion is formed at a tip end portion of the vehicle inner seal lip, and
at least when the door glass is closed, the door glass and the vehicle inner seal lip hard portion, and the vehicle inner side wall in a region in which the insert member is embedded and the vehicle inner seal lip hard portion, are in contact with each other.

6. The glass run according to claim 5, wherein the insert member has a substantially U-shaped cross section in the trim portion, and is continuously formed and embedded from the door glass side of the vehicle outer flange portion into the vehicle inner side wall.
